(19) United States
(12) Patent Application Publication
(10) Pub. No.: US 2001/0049638 A1
(43) Pub. Date: Dec. 6, 2001

(54) System and method for providing mediator services between service provider and service purchaser, and computer program for same

(75) Inventor: Yutaka Satoh, Tokyo (JP)

Correspondence Address: David A. Blumenthal, FOLEY & LARDNER, Washington Harbour, 3000 K Street, N.W., Suite 500, Washington, DC, 20007-5109, US

(73) Assignee: NEC CORPORATION

(21) Appl. No.: 09/864,183

(22) Filed: May 25, 2001

(30) Foreign Application Priority Data
May 29, 2000 (JP) 2000-158744

(51) Int. Cl. G06F 17/60

(52) U.S. Cl. 705/26; 705/1

(57) ABSTRACT

A method and system that enables a mediator server to provide opportunities for individuals to sell and buy services between them. Mediator server acts as an intermediary agent to support the service transactions occurring between service providers and service purchasers. Mediator server is connected to a service provider terminal and to a service purchaser terminal over a network. The mediator server contains a database for a list of service providers, and the mediator server presents the list of service providers to the service purchaser for display on the service purchaser terminal, from which the service purchaser selects the service provider expected to offer the service desired. Responsive to selection of the service provider by the service purchaser, the mediator server transfers a service purchase request to the appropriate service provider for display on the service provider terminal, to allow the service provider to decide on whether to accept or decline the request, based on the information in the request. This decision is communicated to the mediator server, which transfers it to the service purchaser.

### FIELD OF THE INVENTION

The present invent ion relates to a method and system that provides the transaction mediator (or broker) services between service providers and service purchasers, and more particularly to a method and system best adapted for applications where services such as welfare services, educational services, and the like are offered and purchased, and a computer-readable program for performing same.

### BACKGROUND OF THE INVENTION

In the prior art, the service selling and buying activities, i. e., service transactions that occur between individual persons are supported by the local or regional government offices or nonprofit organizations (NPO), for example, which provide the mediator services between those individual persons, that is, the service provider and the service purchaser.

In this case, a service provider who wants to offer a particular service must in advance have the service registered in the local government office or nonprofit organization by providing the required documents describing the service and other associated information, whereas a service purchaser who wants to purchase a particular service must in advance submit to the local government office or nonprofit organization any required information related to the service that the service purchaser is interested in. For example, the service purchaser who is interested in a particular service may have the opportunity to look at the listing of the service providers that have been registered as well as the contents of the services offered by those service providers. Then, the service purchaser may select one of the service providers who are expected to provide the service that best meets the needs of the service purchaser. Actually, the service selected by the service purchaser may be offered through any qualified agent who acts as an intermediary between the two parties interested, i.e., the service provider and the service purchaser.

### SUMMARY OF THE DISCLOSURE

It should be noted, however, that the conventional transaction mediator services offered by the mediator agent are not fully utilized because the mediator agent provides fewer opportunities for either of the service provider or service purchaser to have access to the information offered by the other.

When the service provider, for one part, wants to offer any particular service, the service provider must visit any authorized agent or location, such as the public employment agency, in order to know the site where the service provider could make the service available to the public. When the service purchaser, for the other part, wants to receive any particular service, the service purchaser must also visit any authorized agent or location, such as the public employment agency, in order to look for the service providers that provide that service.

Additionally, because the current transaction mediating activities are limited to the particular sites or areas where services are offered and purchased between the individuals, they could not be extended to include other sites where more services are available.

Based on the recognition of the prior art problems described above, it is therefore an object of the present invention to provide a system and method that enables the individual persons to have more opportunities to sell and purchase services by utilizing a computer network, and a computer program or software to implement the system and method of the present invention.

Other objects, features, and advantages of the present invention will become apparent to any person skilled in the relevant art from the following description that is made in reference to the embodiments of the present invention shown in the accompanying drawings.

In the first aspect of the present invention, there is provided a method using a transaction mediator server, termed herein as “mediator server”, connectable with a service purchaser's terminal and a service provider's terminal over a communication network, wherein the mediator server acts as an intermediary agent between the service purchaser and service provider and wherein the method allows the mediator server to provide the mediator services by presenting the services offered by the service purchaser and associated information to the service purchaser, and by presenting the service being purchased by the service purchaser and associated information to the service provider.

More specifically, the mediator server may present the listing of service providers, services offered by each of the service providers and information related to those services to potential service purchasers, allowing a service purchaser to select the service provider who provides the appropriate service from the listing. When the service purchaser has selected any particular service provider, the service purchaser may submit the specific service purchase request information to the mediator server, who may present the information to that particular service provider. Negotiations may then proceed between the service purchaser and service provider through the mediator server, and the agreement may be reached when the service provider accepts the service purchase request.

Currencies that are applicable in paying for the service may include different kinds of currencies, such as Japanese Yen, U.S. dollar, and any regional prevailing currencies.

According to a second aspect of the present invention there is provided a system which includes a mediator server communicatable with a service provider's terminal and a service purchaser's terminal over a network, wherein the mediator server includes a database on which the registered service providers, the services offered by the respective service providers, and the information related to those services are stored and maintained. More specifically, the mediator server further includes means for sending the listing of services offered by the registered service providers and associated information stored on the database to any potential service purchaser. This listing may be displayed on the service purchaser terminal, on which the service purchaser may select one of the service providers that is expected to meet the needs of the service purchaser. The mediator server also includes means for transferring the service purchase request information submitted by the service purchaser to that service provider for display on the service provider terminal. Then, negotiations may proceed between the service provider and service purchaser on the respective terminals through the mediator server.

The service transaction mediating system allows the service provider to make a decision on whether the service requested by the service purchaser is to be supplied or not (accept or decline), by looking at the service purchase request information that has been transferred from the mediator server and displayed on the service provider terminal. Then, the information regarding the decision made by the service provider (accept or decline) may be passed to the mediator server, from whom this decision may be notified to the service purchaser.

The above object may also be attained by the features as defined in the appended claims or any combination of the features thereof, as it will become apparent from the following description that is made by referring to the accompanying drawings, in which:

### BRIEF DESCRIPTION OF THE DRAWINGS

FIG. 1 illustrates the system configuration according to one embodiment of the present invention;

FIG. 2 is a flowchart that depicts the registration procedure for the service provider according to one embodiment of the present invention;

FIG. 3 is a flowchart that depicts the registration procedure for the service purchaser according to one embodiment of the present invention;

FIG. 4 shows one example of the service provider registration display screen according to one embodiment of the present invention;

FIG. 5 shows one example of the service purchaser registration display screen according to one embodiment of the present invention;

FIG. 6 is a flowchart that depicts the registration procedure for the purchase request information according to one embodiment of the present invention;

FIG. 7 shows one example of the service type list-selection display according to one embodiment of the present invention;

FIG. 8 shows one example of the service selection display (service provider list-selection display) according to one embodiment of the present invention;

FIG. 9 is a flowchart that depicts the procedure that allows the service provider to made a decision on whether the service requested by the service purchaser is to be supplied or not (accept or decline) according to one embodiment of the present invention; and

FIG. 10 shows one example of the service purchase request information list display according to one embodiment of the present invention.

### PREFERRED EMBODIMENTS OF THE INVENTION

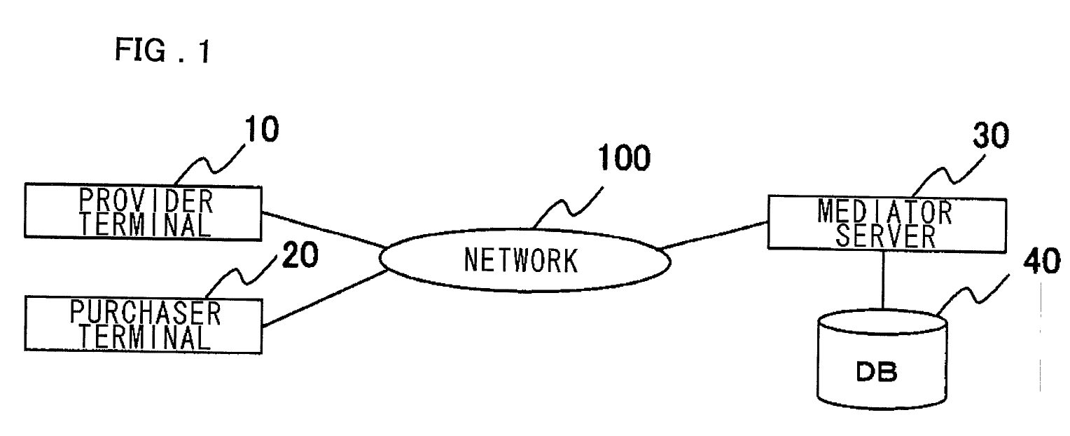

Referring first to FIG. 1, the embodiments of the present invention are now described. As shown in FIG. 1, the service provider may use a terminal 10 to submit information related to the service that the service provider wants to offer. For example, the service information may include the following items or fields:

(a) the name of the service provider

(b) where to contact

(c) the content of the service offered

(d) offered price

This information may be sent to a mediator sever 30 over the communication network 100 so that it may be registered on the mediator server 30.

Upon receiving the information transmitted from the service provider through the terminal 10 and over the network 100, the mediator server 30 may store the information in the database (DB) 40 as the service offering registration information.

On the other hand, the service purchaser may use a terminal 20 to submit a purchaser identification information, which may include the following items or fields:

(a) the name of the service purchaser

(b) address

(c) where to contact

This information may be sent to the mediator server 30 over the network 100.

Upon receiving the purchaser identification information transmitted from the service purchaser through the terminal 20 over the network 100, the mediator server 30 may store the information in a database (DB) 40 as a purchaser registration information.

The service offering registration information stored in the database (DB) 40 may be transferred from the mediator server 30 to the service purchaser over the network 100, and the service purchaser may then select the service provider that offers the service in which the service purchaser is interested and the type of the service, from the service registration information that appears on the terminal 20. Then, the service purchaser may send a service purchase request that describes the information, such as the selected service provider, the type of the service, and when and where to receive that service, back to the mediator server 30 over the network 100.

Upon receiving the service purchase request information, the mediator server 30 may transfer it over the network 100 to a service provider selected by the service purchaser so that it can be displayed on the terminal 10.

In response, the service provider may look at the service purchase request information in order to check to see that the service is available, and may then make a decision on whether the service is to be supplied or not (accept or decline). The decision made by the service provider may be communicated to the mediator server 30 over the network 100.

The decision received by the mediator server 30 may then be transferred to the service purchaser over the network 100.

If the decision made by the service provider is “accept”, the service may become available to the service purchaser.

After the service is completed, the service purchaser may pay the service provider for the service.

It may be understood from the above description that the present invention allows the negotiations between the service provider and service purchaser to proceed through the mediator server, wherein the negotiations may occur on the computer system on the mediator server that is connected to the service provider terminals and to the service purchaser terminals over the network. The services that are sold and purchased , i. e., services for transaction, may include childcare, household, welfare, education and the like, which residents in the regional community may utilize. The appropriate business model or business method programming may implement negotiations that occur between the service provider and service purchaser through the mediator server.

More specifically, the present invention includes a terminal used by (e.g., assigned to) the service provider (referred to as “provider terminal”), a terminal used by (e.g., assigned to) the service purchaser (referred to as “purchaser terminal”), and a mediator sever (i. e., host server) that acts as an intermediary agent between the service provider and service purchaser and has a database, the provider terminal, service purchaser terminal and mediator server being interconnected through a communication network, wherein the mediator server provides the following steps, which allow the mediator server:

(a) to receive, through the network, the service offering registration information provided by the service provider on the service registration information display appearing on the provider terminal, to receive, through the network, the purchaser identification information provided by the service purchaser on the service purchaser registration display appearing on the purchaser terminal, and to record the received service offering information and purchaser identification information in the database;

(b) to transfer the service offering information submitted by the service provider to the service purchaser over the network;

(c) to receive, through the network, the service purchase request information submitted by the service purchaser who has selected a particular service from the list of the service offering information appearing on the purchaser terminal, and to transfer, through the network, the service purchase request information to an appropriate service provider for display on the provider terminal;

(d) to receive, through the network, the information from the service provider that reflects the decision made by the service provider (accept or decline) by looking at the service purchase request information appearing on the provider terminal, and to record the decision information in the database; and

(e) to transfer the decision information to the service purchaser through the network.

The steps listed in (a) through (e) may be implemented by programming those steps so that they can be performed by the mediator server.

The mediator server may provide the following additional steps, which allow the mediator server:

(f) to send the service type list-selection display to the service purchaser so that the display can be presented on the purchaser terminal as part of the service offering information so as to allow the service purchaser to select any service from the selection list;

(g) in response to the selection of any service type and any required service item in the service type that is made by the service purchaser from the selection list display on the purchaser terminal, to retrieve the service provider registration information associated with the selected service and/or service item from the database, to edit the retrieved service provider registration information to provide a service provider list-selection display, and to transfer the service provider list-selection display to the service purchaser for display on the purchaser terminal, on which the service purchaser may select an appropriate service provider; and

(h) when the service purchaser selects and enters an appropriate service provider from the service provider list-selection display on the purchaser terminal, together with the specific conditions and terms under which the service purchaser is to purchase the service, and after the confirmation is then made by the service purchaser, to receive the appropriate service purchase information from the service purchaser.

The steps listed in (f) through (h) may be implemented by a program implementing the steps so that the mediator server can perform them.

In addition, the mediator server may provide the following steps that allow the mediator server:

(i) in recording the service offering registration information on the database, to generate a registration number to be assigned to the service provider, to record the service provider registration number together with the service offering registration information on the database, and to send the service provider registration number to the appropriate server provider for display on the provider terminal; and

(i) in recording the service purchaser identification information on the database, to generate a registration number assigned to the service purchaser, to register the service purchaser registration number together with the purchaser identification information on the database, and to send the service purchaser registration number to the appropriate service purchaser.

The process steps listed in (i) and (j) may be implemented by program implementing the process so that the mediator server can perform them.

All of the programs that implement the process steps listed above may be stored on any type of storage medium, such as CD-ROM, DVD (digital versatile disk), HDD (hard disk drive), FD (floppy disk), MT (magnetic tape), semiconductor memory and the like, from which the programs may be read, loaded, and executed by a server computer on which the mediator server resides.

Referring now to the drawings, the embodiments are described more specifically, by showing examples of how the present invent ion may be embodied. FIG. 1 illustrates a typical configuration of a service transaction mediating system according to one embodiment of the present invention. In FIG. 1, it is assumed that services, such as childcare, household, health care, education and the like, are subject to transaction, (i.e., sold and purchased) between individual persons.

Referring to FIG. 1, one embodiment of the present invention includes a provider terminal 10, a purchaser terminal 20, a mediator server 30, a database 40 that resides on the mediator server 30, and a network 100, such as the Internet, across which they are interconnected.

The provider terminal 10 may be a personal computer, portable information terminal, portable telephone or the like that contains an information processor, and may be connected to the mediator server 30 over the network 100 to exchange data with the mediator server 30.

The provider terminal 10 provides the function that allows the service provider to communicate with the mediator server 30 over the network 100 in order to have the services offered by the service provider registered in the database (DB) 40 on the mediator server 30.

The service offering registration information, which may be provided by the service provider on the provider terminal 10 and may be recorded on the mediator server's database 40, includes the information specific to the service provider offering the services, such as the name, where to contact and the like, as well as the information concerning the services offered by the service provider, such as the types of services including baby sitter, aged people care, snow removal and the like, for example. Any ancillary information such as instructions as to the payment may be included.

The provider terminal 10 may also provide a function that allows the service provider to make a decision on whether the service provider should accept or decline the service request submitted by the service purchaser, and communicate the decision to the mediator server 30 over the network 100.

The purchaser terminal 20 may be a personal computer, portable information terminal, portable telephone or the like that contains an information processor, and may be connected to the mediator server 30 over the network 100 to exchange data with the mediator server 30.

The purchaser terminal 20 provides the function that allows the service provider to communicate with the mediator server 30 over the network 100 in order to have the information specific to the service purchaser registered in the database (DB) 40 on the mediator server 30.

The registration information, which may be provided by the service purchaser and may be stored in the database 40, includes the identification information specific to the service purchaser, such as the name, address, where to contact and the like, as well as the information that specifies the type of the service to be purchased, such as baby sitter, aged people care, snow removal and the like.

The purchaser terminal 20 may also provide a function that allows the service purchaser to communicate with the mediator server 30 over the network 100, requesting that the mediator server 30 sends the list of available services stored on the database 40 for display on the purchaser terminal 20.

In addition, the purchaser terminal 20 may provide a function that allows the service purchaser to communicate with the mediator server 30 over the network 100, passing the mediator server 30 the information that specifies the service provider who offers the service to be purchased, the type of the service, where and when to receive the service, and the like.

The mediator server 30 provides the function that allows it to receive the desired service purchase information from the service purchaser, generate the service request information from the service purchase information, and send the service request information to the appropriate service provider via e-mail, Fax (facsimile) or other communication medium.

The service request information identifies the service provider and the type of the service offered by the service provider, and is unique to each individual service that is sold and purchased.

In addition, the mediator server 30 provides a function that allows it to receive the decision made by the service provider (accept or decline) in response to the service request information, and transfer the decision to an appropriate service purchaser via e-mail, Fax, or other communication medium.

Referring next to FIGS. 1 through 10, the operation that occurs in accordance with one embodiment of the present invention is described in detail. The following description assumes that the network 100 is the Internet. In this case, the system may be configured to allow the provider terminal 10 and purchaser terminal 20 to have access to the local Internet Service provider (ISP) by making a dial-up call through the public telephone network, and then connect to the Internet via the router on the ISP.

(1) Service Provider Registration

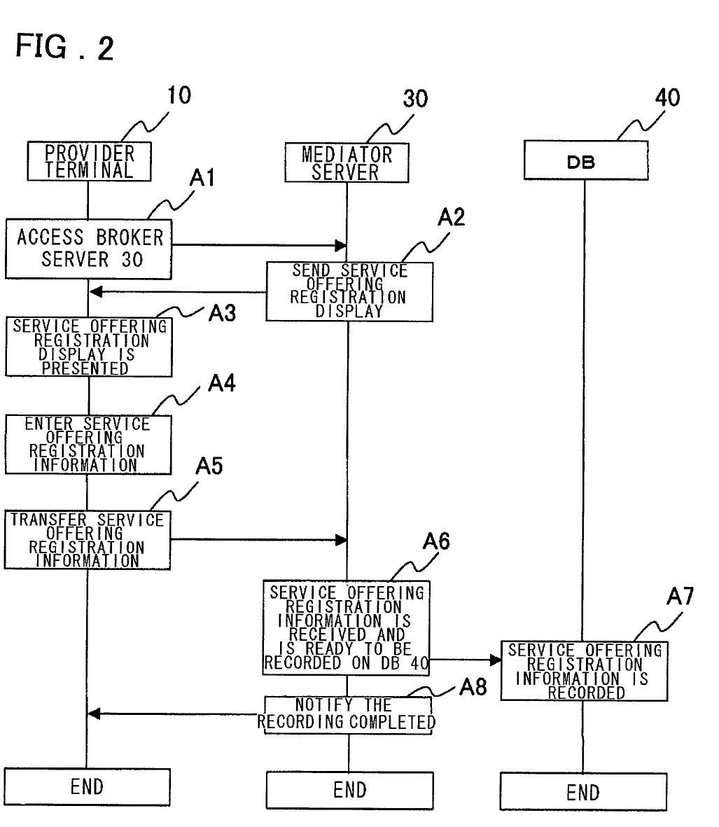

FIG. 2 is a flowchart that depicts the steps in the service provider registration procedure that are followed when the service provider will have the service offering registration information recorded on the database in accordance with one embodiment of the present invention.

Referring to FIG. 2, the service provider may use the browser on the provider terminal 10 to obtain access to the Web site (home page) established by the mediator on the mediator server 30 on the Internet 100 (step A1). In response, the mediator server 30 sends the service offering registration information entry display to the service provider for display on the provider terminal 10 (step A2).

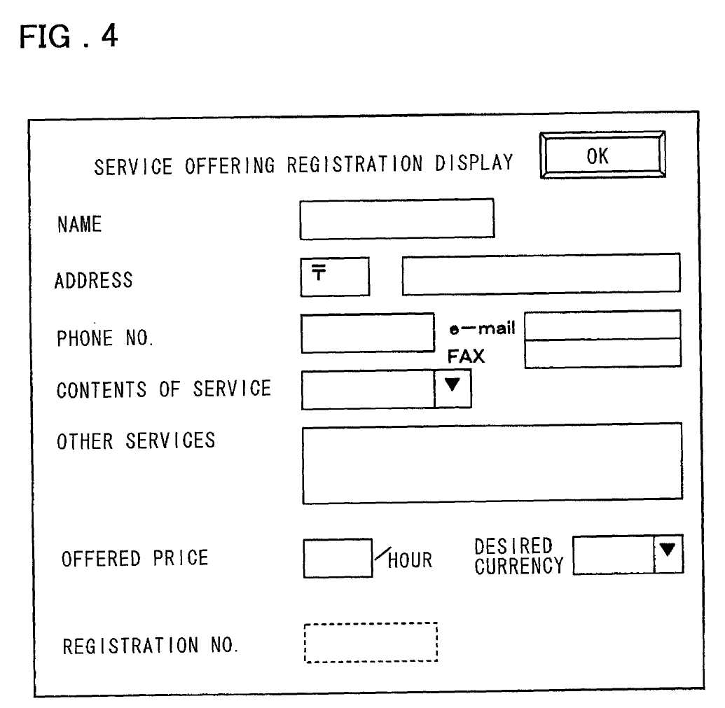

Upon receiving the service offering registration information entry display at the service provider, it is displayed on the provider terminal 10 as shown in FIG. 4, on which the service provider may enter the required information for registration (step A3).

The service offering registration information entry display contains the entry fields into which the service provider may enter the information as required (step A4).

In the example shown in FIG. 4, the entry fields may include:

(a) the name of the service provider,

(b) address,

(c) telephone number,

(d) e-mail address,

(e) Fax number,

(f) the contents of the service offered,

(g) offered price, and

(h) currency specified for payment.

The information entered in the above fields may be stored temporarily on the provider terminal 10.

After the required information has been entered, the service provider may click on the “OK” button on the entry display. This action causes the service offering registration information temporarily stored to be forwarded to the mediator server 30 over the network 100 (step A5).

Examples of the currency that may be specified for payment include regional currencies, such as “Ecomoney” in Japan, “Ithaca hour” in Ithaca, N.Y., USA, and “Bread” in Barkley, USA.

Upon receiving the service offering registration information from the service provider, the mediator server 30 may issue an instruction to have the information recorded on the database 40, and may generate a registration number (No.) to be assigned to the service provider. Then, the mediator server 30 may also issue an instruction to have this registration number recorded on the database 40 (step A6).

In response to those instructions, the service offering registration information and registration number will be stored in the database 40 (step A7).

After making sure that the service offering registration information and registration number have been stored in the database 40 correctly, the mediator server 30 may send the registration number back to the service provider for display on the provider terminal 10 (step A8).

The registration number may be sent to the service provider via e-mail, Fax or other communication medium.

(2) Service Purchaser Registration

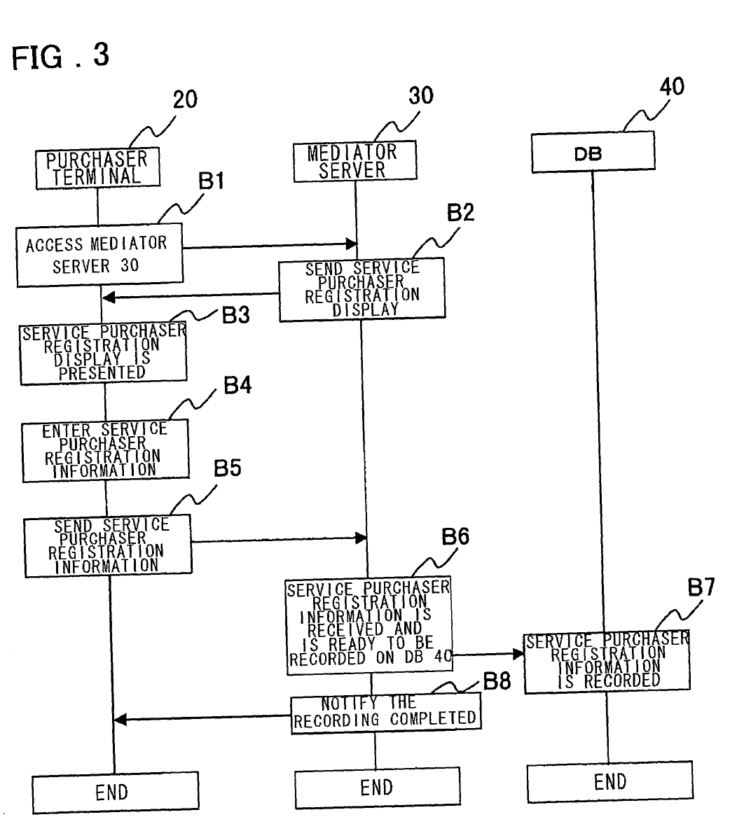

FIG. 3 is a flowchart that depicts the steps in the service purchaser registration procedure that are followed when the service provider will have the service purchaser identification information registered in the database in accordance with one embodiment of the present invention.

Referring to FIG. 3, the service purchaser may use the browser on the purchaser terminal 20 to obtain access to the Web site (home page) established by the mediator on the mediator server 30 on the Internet 100 (step B1). In response, the mediator server 30 may send the service purchaser identification information entry display to the purchaser terminal 20 (step B2).

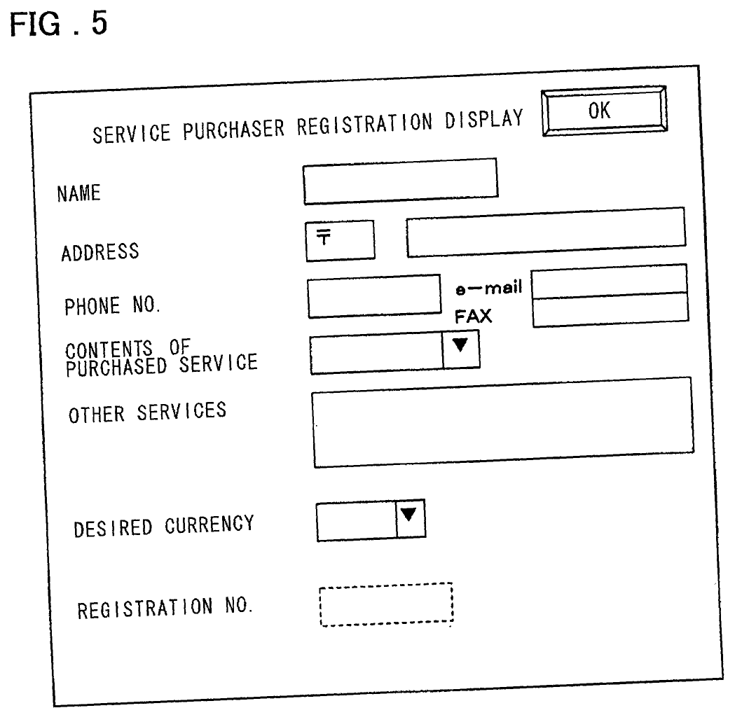

Upon receiving the service purchaser information entry display at the service purchaser, it is displayed on the purchaser terminal 20 as shown in FIG. 5, on which the service purchaser may enter the required information for registration (step B3).

The service purchaser identification information entry display contains the entry fields into which the service purchaser may enter the information as required (step B4).

In the example shown in FIG. 5, the entry fields may include:

(a) the name of the service purchaser,

(b) address,

(c) telephone number,

(d) e-mail address,

(e) Fax number,

(f) the contents of the service to be purchased,

(g) offered price, and

(h) currency specified for payment.

The information entered in the above fields may be stored temporarily on the provider terminal 20.

After the required information has been entered, the service purchaser may click on the “OK” button on the entry display. This action causes the service purchaser identification information temporarily stored to be forwarded to the mediator server 30 over the network 100 (step B5).

Upon receiving the service purchaser identification information from the service purchaser, the mediator server 30 may issue an instruction to have the information recorded on the database 40, and may generate a registration number (No.) to be assigned to the service purchaser. Then, the mediator server 30 may also issue an instruction to have this registration number recorded on the database 40 (step B6).

In response to those instructions, the service purchaser information and registration number will be stored in the database 40 (step B7).

After making sure that the service purchaser identification information and registration number have been stored in the database 40 correctly, the mediator server 30 may send the registration number back to the service purchaser for display on the purchaser terminal 20 (step B8).

The registration number may be sent to the service provider via e-mail, Fax or other communication medium.

(3) Purchase Request Information Registration

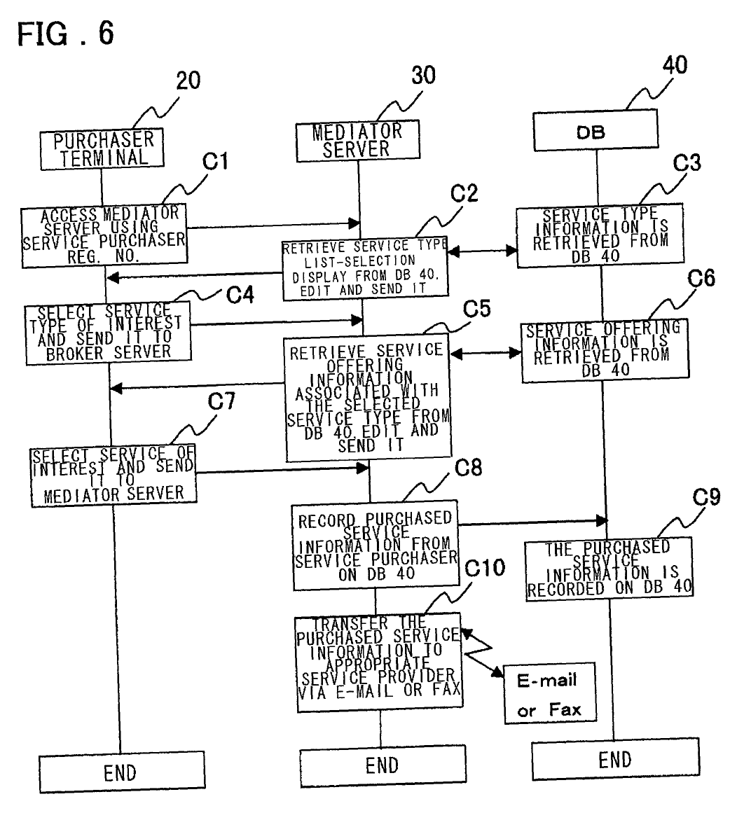

FIG. 6 is a flowchart that depicts the steps in the purchase request information registration procedure that are followed when the service purchaser will have the purchase request information registered in accordance with one embodiment of the present invention.

Referring to FIG. 6, the service purchaser may use the purchaser terminal 20 to obtain access to the Web site (home page) established by the mediator on the mediator server 30 on the Internet 100 (step C1).

In response, the mediator server 30 may access the database 40 to search for the service type information stored therein (step C3). When this information is found, the mediator server 30 may edit the information to generate the service type selection list-entry display. Then, this entry display may be sent to the purchaser terminal (step C2).

Upon receiving the service type selection list-entry display at the service purchaser, it is displayed on the purchaser terminal 20, on which the service purchaser may select the desired service type by clicking it using the mouse. Then, the list of service items in the service type selected will appear on the display.

Upon selecting one service item from the list by clicking this service item using the mouse and then clicking “OK” button, the information for the selected service item will be forwarded to the mediator server 30 (step C4).

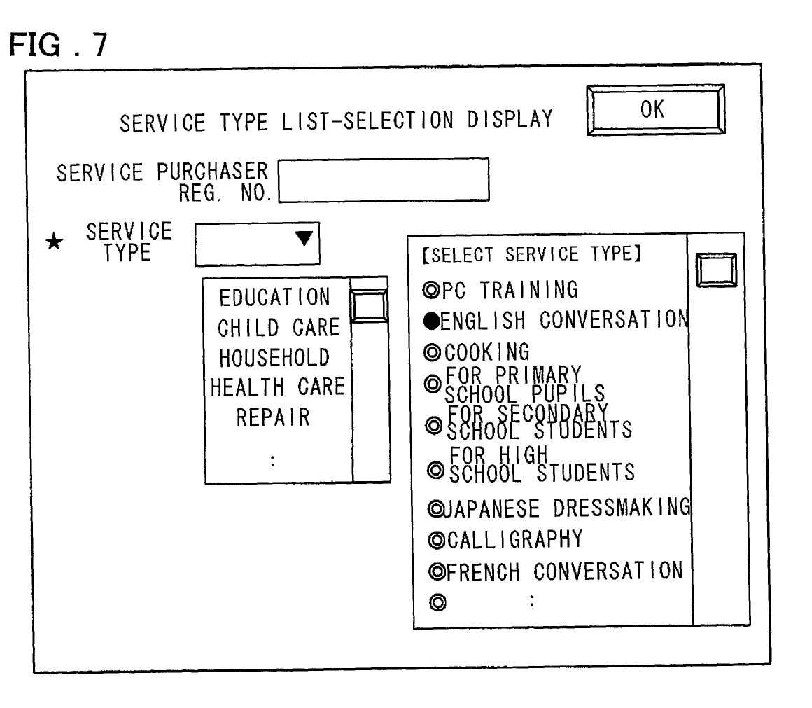

FIG. 7 shows one example of the service type selection list-entry display. In the example shown in FIG. 7, the service purchaser has selected the service type “education service”, and has then selected the service item “English Conversation”.

In response to the above action, the mediator server 30 may access the database 40 to search for the information for all service providers registered in the database (step C6). When all the applicable information is found, the mediator server 30 may edit it to generate the service provider selection list-entry display, which is forwarded to the purchaser terminal 20 (step C5).

Upon receiving the service provider selection list-entry display at the service purchaser, it is displayed on the purchaser terminal 20, on which the service purchaser may select the appropriate service provider from the list by clicking this item using the mouse. Optionally, the service purchaser may specify the conditions and terms under which the service purchaser is to purchase the service, such as the service start date, the day of the week, the time of the day, the location where the service is to be received, etc. After entering the appropriate data as required, and then clicking “OK” button using the mouse, the data may then be forwarded to the mediator server 30 (step C7).

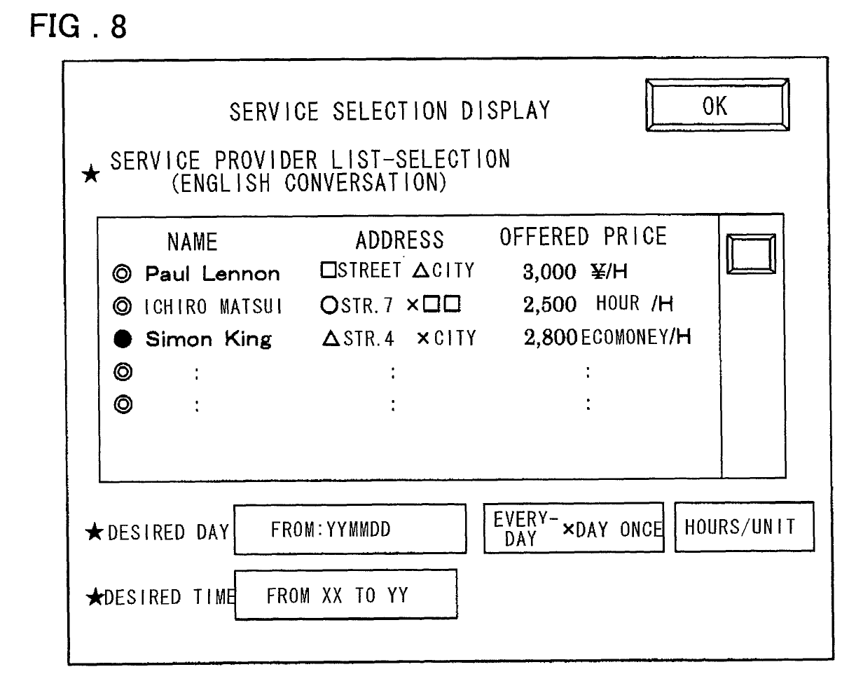

FIG. 8 shows one example of the service selection display. In the example shown in FIG. 8, the service purchaser has selected an item named as “Simon King” from the service provider selection list-entry display (English Conversation) being displayed on the purchaser terminal 20.

Upon receiving the desired service purchase information from the purchaser terminal 20, the mediator server 30 will have the information recorded on the database 40 (steps C9 and C8).

At the same time, the mediator server 30 may transfer the desired service purchase information to the appropriate service provider via e-mail, Fax or other communication medium (step C10).

(4) Decision by Service Provider to Accept or Decline the Purchase Request

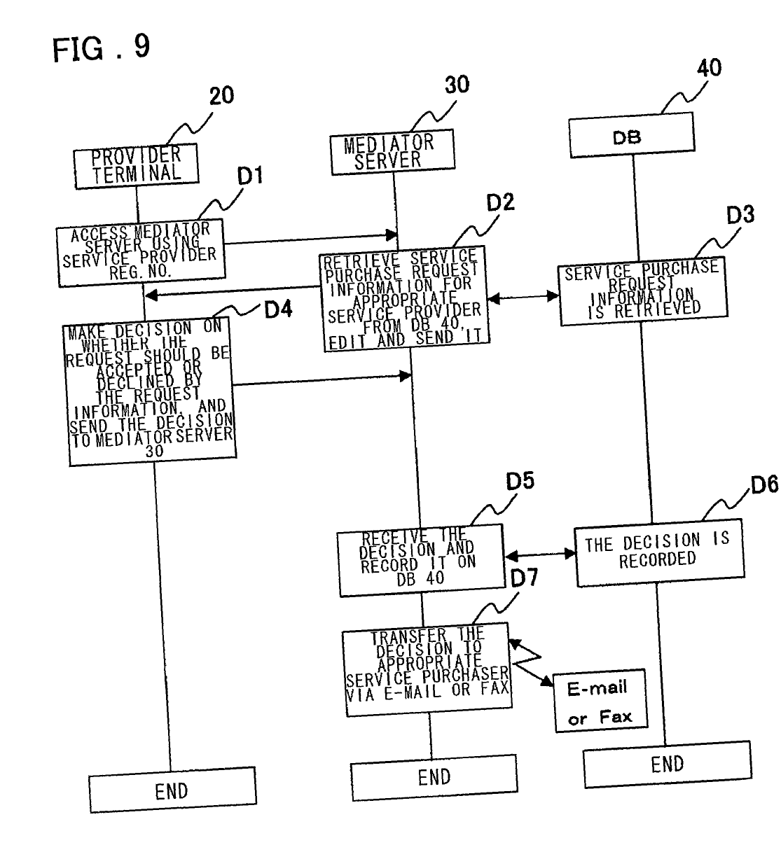

Referring to FIG. 9, the service provider may use its own registration number on the provider terminal 10 to obtain access to the Web site (home page) established by the mediator on the mediator server 30 on the Internet 100 (step D1). In response, the mediator server 30 may access the database 40 to search for the service requests made by potential service purchasers against that service provider and that are registered in the database 40 (step D3). When those service requests are found, the mediator server 30 may edit the potential service purchaser list information to generate the service purchase request information list display, which may be forwarded to the appropriate service providers for display on the respective provider terminals 10 (step D2).

When the service provider receives the service purchase request list information display, it will be displayed on the provider terminal 10. By looking at the potential service purchaser list information on the service purchase request list information display, the service provider may have the option to accept or decline each of the individual requests. Specifically, looking at the service purchase conditions and terms (service purchase start date, the day of the week, the time of the day, service usage location) for each potential service purchaser may make this decision. For each individual potential service purchaser, then, the service provider may use the mouse to click “YES” (accept) button or “NO” (Decline) button, depending on the decision made by the service provider, and then click “OK” button. This action causes the decision to be communicated to the mediator server 30 (step D4).

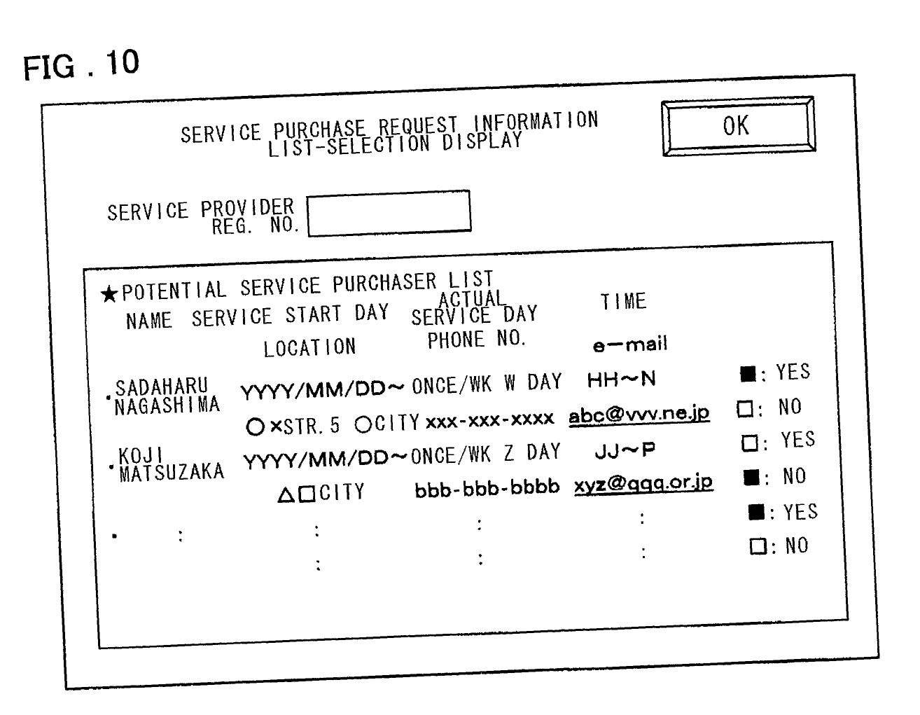

FIG. 10 shows one example of the service purchase request list information display. In the example shown in FIG. 10, the service provider has accepted the purchase request made by “Nagashima Sadaharu”, and has declined the purchase request made by “Matuzaka Koji”.

In response to the decision made by the service provider, the mediator server 30 may have the respective decision recorded on the database 40 (steps D6 and D5).

At the same time, the mediator server 30 may notify the appropriate service purchaser of the decision (accept or decline) via e-mail, Fax, or other communication medium (step D7).

If the terminals 10 and 20 include the browsing function that allows the user to access the mediator's Web site (home page), the user can use all of the functions provided by the present invention to request the mediator server that the user is registered as the service provider or service purchaser and stored in the database, to select the desired service, to make a decision on whether to purchase the service or not, and the like.

Computer programs that are executed on the mediator server 30 may implement the process steps that occur at the mediator server 30 in accordance with the embodiments of the present invention described so far. Thus, one advantage of the present invention is that any type of existing terminals can be used in conjunction with the present invention, without having to develop a specialized terminal or modify the existing terminal.

Although the present invention has been described in reference to the particular embodiments, it should be understood that the descriptions appearing on the drawings, in particular the information on the displays or the display layouts, are only presented by way of example and for the illustrative purposes, and therefore are not restrictive. It should also be understood that the present invention is not limited to the described embodiments, which may be modified in various ways without departing from the spirit and scope of the present invention as defined in the appended claims, as it is apparent to any person skilled in the relevant art.

The meritorious effects of the present invention are summarized as follows.

It may be appreciated from the foregoing description that the present invention provides several advantages that will be described below.

One advantage of the present invention is that it provides more opportunities for individual persons or parties to participate in the service business activities by allowing them to access the information related to the services that are offered and purchased over the Internet, and that it contributes to the enhanced welfare services by allowing the individual persons to help each other in the regional communities.

In the prior art, when there are potential service providers who are qualified to offer services and potential service purchasers who want to utilize the services, the distribution of the information is limited to the local areas (cities, towns, villages) where they live, and the information is only available through the word-of-mouth communication or the like in the limited local areas. In contrast, the present invention makes the service information open and accessible to the public so that every service purchaser can find the service that might best fit the needs of the service purchaser, whereas service providers can supply the service that might best satisfy the needs of the service purchaser by looking at the specific service request information submitted by the service purchaser to determine whether the service should be supplied or not. Thus, the present invention provides the environment where the service providers may supply services that are expected to satisfy the needs of potential service purchasers, while the potential service purchasers may benefit from the service by choosing the best service among the services offered by different service providers.

Another advantage of the present invention is to provide more opportunities for qualified individual persons, such as retired workers, household wives, and jobless persons, to find service jobs assumed to be the best by the service purchaser. This may substantially reduce the rate of unemployment.

A further advantage of the present invention is to allow any regional currencies to be specified when the service provider and service purchaser negotiate on terms and conditions regarding the payment for the services.

As it may be apparent from those advantages, the present invention provides the higher practical value.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items might fall under the modifications aforementioned.

What is claimed is:

1. A method for allowing a mediator server to act as an intermediary agent between a service provider and a service purchaser comprising the steps of;
(a) providing a mediator server communicatable with at least one service provider and at least one service purchaser through their respective terminals over a communication network, and
(b) receiving at said mediator server service offering information including the service provider's name, offered services and other information from said service provider,
(c) forwarding said service offering information to said service purchaser from said mediator server,
(d) at said mediator server receiving purchase service request information including the service purchaser's name, service being purchased and other information from said service purchaser, and
(e) forwarding said purchase service request information to said service provider from said mediator server, wherein said mediator server acts as an intermediary agent between the service provider and the service purchaser.

2. The method as defined in claim 1, wherein upon receiving the service offering information from service providers, said mediator server forwards a listing of service providers, offered services and associated information to at leaset service purchaser's terminal;
said mediator server allows said service purchaser to select a particular service provider from said listing displayed on the service purchaser's terminal, there upon said mediator server forwards the service purchase request information to said particular service provider selected by said service purchaser for display on said service provider's terminal; and
through said mediator server and based on the service purchase request information displayed on the service provider's terminal, said service provider is allowed to accept the service purchase request, there upon to reach an agreement between said particular service provider and said service purchaser.

3. The method as defined in claim 1, wherein several kinds of currencies are applicable when the service offered by said service provider and received by said service purchaser is paid for.

4. A method for allowing a mediator server to act as an intermediary agent between a service provider and a service purchaser when services are sold and purchased between the service provider and service purchaser wherein said mediator server, said service provider and said service purchaser can communicate with each other through their respective terminals over a communication network and wherein said method includes the steps of:
(a) allowing said service provider to send the service offering registration information from said service provider's terminal, referred to as “provider terminal” to said mediator server over the network;
(b) allowing said mediator server to record, in adatabase, the service offering registration information received from said provider terminal;
(c) allowing said service purchaser to send the service purchaser identification information from said service purchaser's terminal, referred to as “purchaser terminal” to said mediator server over the network;
(d) allowing said mediator server to record, in said database, the service purchaser identification information received from said purchaser terminal;
(e) allowing said service purchaser to select a particular service purchase information from said service offering information displayed on said purchaser terminal, and send the selected service purchase information from said purchaser terminal to said mediator server over the network;
(f) in response to said service purchase information received from said service purchaser, allowing said mediator server to create the service purchase request information for forwarding it to the service provider selected by said service purchaser for display on said provider terminal;
(g) allowing said service provider, based on the service purchase request information received from said mediator server and displayed on said provider terminal, to make a decision on whether said service provider should accept or decline the service purchase request, and to notify the resulting decision to said mediator server over the network; and
(h) allowing said mediator server to forward said decision received from said service provider to said service purchaser over the network, wherein if the decision made by said service provider is to accept the service purchase request, it is determined that an agreement is reached between said service provider and said service purchaser, and the service is supplied from said service provider to said service purchaser.

5. The method as defined in claim 3, further including the step of:
(i) causing said service purchaser to pay said service provider for the service supplied by said service provider and received by said service purchaser when it is completed, wherein said service purchaser and said service provider may optionally select any one among several different currencies agreed upon by said service provider and said service purchaser to pay for the service received.

6. A service transaction mediating system for allowing a mediator server to act as an intermediary agent in service transaction between a service provider and a service purchaser, wherein
said mediator server, service providers and service purchasers are communicatable with each other through their respective terminals over a communication network;
said mediator server includes a database on which the service offering registration information submitted by said service provider is recorded;
said mediator server includes means for allowing said mediator server to send a listing of services offered from said service providers and recorded on said database to any of said service purchasers and for allowing said service purchaser to select any particular service provider from said listing being displayed on said service purchaser's terminal, whereby said service purchaser and said service provider may use their respective terminal to conduct the service transaction through said mediator server.

7. The system as defined in claim 6, further including:
means for allowing said service provider to make a decision on whether said service provider should accept or decline the service purchase request, based on said service purchase request information being displayed on said service provider's terminal, and for allowing said service provider to notify the decision to said mediator server; and
means for allowing said mediator server to forward the notification of said decision received from said service provider to said service purchaser.

8. The system as defined in claim 6, wherein several kinds of currencies are applicable when the service offered by said service provider and received by said service purchaser is paid for.

9. A transaction mediating system for allowing a mediator server to act as an intermediary agent on service transaction between a service provider and a service purchaser comprising:
a terminal used by a service provider, referred to as “provider terminal”;
a terminal used by a service purchaser referred to as “purchaser terminal”; and
a mediator server having a database and being connectable to said provider terminal and to said purchaser terminal over a network, wherein
(a) said provider terminal includes means for allowing said service provider to provide the service offering registration information on the service offering registration entry display appearing on said provider terminal, and to send said service offering registration information to said mediator server over the network;
(b) said purchaser terminal includes means for allowing said service purchaser to provide the purchaser identification information on the service purchaser registration entry display appearing on said purchaser terminal, and to send said purchaser identification information to said mediator server over said computer network; and
(c) said mediator server includes means for allowing said mediator server to record the service offering registration information received from said provider terminal and the purchaser identification information received from said purchaser terminal on said database, and wherein
(d) said purchaser terminal further includes means for displaying the service offering information received from said mediator server on said purchaser terminal, and for allowing said service purchaser to identify and select a service to be purchased from the service offering information, to enter the service purchase information including the identified and selected service, and to send the service purchase information to said mediator server over the network;
(e) said mediator server further includes means for allowing said mediator server to produce a service purchase request information from said service purchase information received from said purchaser terminal, and forward the service purchase request information to the service provider of the selected service for display on said provider terminal;
(f) said provider terminal further includes means for allowing said service provider, based on said service purchase request information displayed on said provider terminal, to make a decision on whether said service provider should accept or decline said service purchase request, and to send the information for the decision back to said mediator server; and
(g) said mediator server further includes means for recording the decision information received from said service provider on said database, and means for notifying the decision to said service purchaser,
(h) whereby said service purchaser may be ready to receive the service offered by said service provider when said service provider makes the decision to accept the service purchase request submitted by said service purchaser.

10. The system as defined in claim 9, wherein
said mediator server further includes means for allowing said mediator server to generate a registration number to be assigned to the service provider prior to recording said service offering registration information on said database, to record the service provider registration number together with said service offering registration information on said database, and to send said service provider registration number to said service provider for display on said provider terminal; and
said mediator server further includes means for allowing said mediator server to generate a registration number to be assigned to the service purchaser prior to recording the purchaser identification information on said database, to record the service purchaser registration number together with said purchaser identification information on said database, and to send said service purchaser registration number to said service purchaser for display on said purchaser terminal, whereby
said purchaser terminal allows said service purchaser to have access to said mediator server by using said service purchaser registration number; and
said provider terminal allows said service provider to have access to said mediator server by using said service provider registration number.

11. The system as defined in claim 9, wherein
when said service purchaser pays said service provider for the service offered by said service provider and received by said service purchaser when it is completed, said service purchaser and said service provider may optionally select any one among several different currencies agreed upon by said service provider and said service purchaser to pay for the services.

12. The system as defined in claim 9, wherein
on the purchaser terminal, when the service offering information is received from said mediator server, a service type list-selection display on which service types offered by said service provider are listed is displayed;
the purchaser terminal allows said service purchaser to select a service type from said service type list-selection display, and optionally select a particular service item from service items listed in the service type selected;
in response to the selection made on said purchaser terminal, said mediator server is caused to access said database in order to search for the information for the service providers that offer the service type and/or service item selected by said service purchaser, and if found, is caused to edit said service provider information to produce a service provider list-selection display, and send the service provider list-selection display to said purchaser terminal for display; and
the purchaser terminal allows said service purchaser to select a service provider that offers the service being purchased from said service provider list-selection display, and optionally enter the terms and conditions under which the service is to be purchased, wherein upon confirmation of the desired service, the service purchase information is transferred to said mediator server.

13. The system as defined in claim 9, wherein the service offering registration information display on said provider terminal contains the following entry fields: the name of the service provider, the location of the service provider to contact, the contents and price of the offered service, and the currency designated for use in paying for the service offered.

14. The system as defined in claim 9, wherein the service purchaser registration display on said purchaser terminal contains the following entry fields: the name of the service purchaser, the location of the service purchaser to contact, the content of the purchased service, and the currency designated for use in paying for the service received.

15. The system as defined in claim 9, wherein said service provider list-selection display contains the following fields: the service provider names, locations to contact and offered unit prices, including the following entry fields: the start date and hours on and during which the service is desired to be received from the service provider selected from the list.

16. The system as defined in claim 9, wherein said service purchase request information display contains a list of service providers, including the following fields: the service provider names, service start date, location where the service is offered, service days and hours, and location to contact, and further includes a service provider registration number entry field and action fields.

17. A mediator server apparatus, said mediator server apparatus being connectable to service provider terminals and to service purchaser terminals over a network and comprising:
means for allowing said mediator server to record services offered by said service provider terminal on a database;
means for allowing said mediator server to send a list of service providers to a service purchaser for display on said service purchaser terminal so that said service purchaser can select a service purchaser from the list of service providers being displayed on said service purchaser terminal; and
means for allowing said mediator server to send a service purchase request information for the service selected by said service purchaser to said service provider for display on said service provider terminal.

18. The mediator server apparatus as defined in claim 17, wherein
said service provider terminal includes means for allowing the service provider to make a decision on whether said service provider should accept or decline the service purchase request, based on the service purchase request information received from said mediator server, and
wherein said mediator server apparatus further includes means for allowing the mediator server to forward the decision made by said service provider to said service purchaser over a communication medium.

19. A mediator server apparatus to act as an intermediary agent in the service transaction between a service provider and a service purchaser, said mediator server apparatus having a database and being connectable to a terminal used by said service provider referred to as “provider terminal”, and to a terminal used by said service purchaser, referred to as “purchaser terminal”, over a network, the apparatus comprising:
means for allowing said mediator server to receive, over the network, a service offering registration information provided by said service provider on a service registration information entry display on said provider terminal and a purchaser identification information provided by said service purchaser on a service purchaser registration entry display on said purchaser terminal, and to record said service offering registration information and said purchaser identification information on said database;
means for allowing said mediator server to receive the service offering information from said service provider and transfer said service offering information to said purchaser terminal;
means for allowing said mediator server to receive, from said purchaser terminal and over the network, the service purchase information containing the service to be purchased that is provided by said service purchaser selecting a desired service from said service offering information displayed on said purchaser terminal and entering any required purchase information together with the selected service on said purchaser terminal, and to transfer a service purchase request information to the provider terminal on the service provider offering said selected service;
means for allowing said mediator server to receive, from said provider terminal and over the network, the decision on whether to accept or decline the service purchase request that is made by said service provider looking at said service offering information displayed on said provider terminal, and record the information on the decision, i. e. accept or decline, on said database; and
means for allowing said mediator server to notify the decision to said service purchaser, whereby when the decision made by said service provider is to accept the service purchase request, the agreement between said service provider and said service purchaser is determined to be reached, and the service selected by said service purchaser may be supplied by said service provider to said service purchaser.

20. The mediator server apparatus as defined in claim 19, further comprising:
means for allowing said mediator server to generate a registration number to be assigned to said service provider prior to recording said service offering registration information on said database, to record the generated service provider registration number together with said service offering registration information on said database, and to send said service provider registration number to said provider terminal; and
means for allowing said mediator server to generate a registration number to be assigned to said service purchaser prior to recording said purchaser identification information on said database, to record the generated service purchaser registration number together with said purchaser identification information on said database, and to send said service purchaser registration number to said purchaser terminal, whereby said service purchaser on said purchaser terminal may have access to said mediator server by using said service purchaser registration number, and said service provider on said provider terminal may have access to said mediator server by using said service provider registration number.

21. A computer readable program product for performing, service transactions on a mediator server, said mediator server acting as an intermediary agent, service transactions between a service provider and a service purchaser, and said mediator server having a database and being connectable to a terminal used by said service provider referred to as “provider terminal”, and to a terminal used by said service purchaser referred to as “purchaser terminal”, over a network,
wherein the program product causes the mediator server to perform the steps comprising:
(a) allowing said mediator server to receive, over the network, a service offering registration information provided by said service provider on a service registration information entry display at said provider terminal, and a purchaser identification information provided by said service purchaser on a service purchaser registration entry display at said purchaser terminal, and to record said service offering registration information and said purchaser identification information on said database;
(b) allowing said mediator server to receive the service offering information from said service provider and transfer said service offering information to said purchaser terminal;
(c) allowing said mediator server to receive, from said purchaser terminal and over the network, the service purchase information containing a service to be purchased that is provided by said service purchaser selecting the desired service from said service offering information displayed on said purchaser terminal, and entering any required purchase information together with the selected service on said purchaser terminal, and to transfer a service purchase request information to the provider terminal on the service provider offering said selected service;
(d) allowing said mediator server to receive, from said provider terminal and over the network, the decision on whether to accept or decline the service purchase request made by said service provider looking at said service offering information displayed on said provider terminal, and record the information on the decision, i. e., accept or decline, on said database; and
(e) allowing said mediator server to notify the decision to said service purchaser.

22. The program product as defined in claim 21, wherein said program product further comprises the steps of:
(f) enabling said mediator server to provide a service type list-selection display on which service types offered by said service provider are listed, and send the service type list-selection display to said purchaser terminal for display on said purchaser terminal as part of the service offering information;
(g) enabling said mediator server to provide an opportunity for said service purchaser to select a desired service type from said service type list-selection display displayed on said purchaser terminal, and if required, to select a particular service item from the service items listed in the service type selected, and for enabling said mediator server to respond to said selection made by said service purchaser for searching in said database for the information for the service providers associated with said selected service type recorded on said database, and if found, to edit the service provider information to provide a service provider list-selection display and send it to said service purchaser for display on said purchaser terminal; and
(h) enabling said mediator server to provide an opportunity for said service purchaser to select a service provider that offers the service to be purchased from said service provider list-selection display and optionally enter the terms and conditions under which the service is to be purchased, and for enabling said mediator server to receive the service purchase information from said service purchaser when the desired service is confirmed by said service purchaser.

23. The program product as defined in claim 20 or 21, wherein said program product further comprises the steps of:
(i) enabling said mediator server to generate a registration number to be assigned to said service provider prior to recording said service offering registration information on said database, to record the generated service provider registration number together with said service offering registration information said database, and to send said service provider registration number to said provider terminal; and
(i) enabling said mediator server to generate a registration number to be assigned to said service purchaser prior to recording said purchaser identification information on said database, to record the generated service purchaser registration number together with said purchaser identification information on said database, and to send said service purchaser registration number to said purchaser terminal.
